(19) United States
(12) Patent Application Publication
(10) Pub. No.: US 2018/0213185 A1
(43) Pub. Date: Jul. 26, 2018

(54) METHOD AND SYSTEM FOR MONITORING A SCENE BASED ON A PANORAMIC VIEW

(71) Applicant: Shanghai Xiaoyi Technology Co., Ltd., Shanghai (CN)

(72) Inventors: Weizheng ZENG, Beijing (CN); Chao HE, Beijing (CN); Weilong GAO, Beijing (CN); Xiaoxi ZHENG, Beijing (CN)

(73) Assignee: Shanghai Xiaoyi Technology Co., Ltd.

(21) Appl. No.: 15/595,989

(22) Filed: May 16, 2017

(30) Foreign Application Priority Data
Jan. 20, 2017 (CN) 201710051715.3

(51) Int. Cl. H04N 7/18; H04N 5/232; G06K 9/00; G08B 13/196

(52) U.S. Cl. CPC H04N 7/181; H04N 5/23238; H04N 5/23293; G06K 2009/00738; G06K 9/00771; G08B 13/196; G06K 9/00744

(57) ABSTRACT

Methods and systems for monitoring a scene based on data generated in real time representing a panoramic view are disclosed. A method of the present disclosure includes capturing a scene by multiple capturing units, generating, in real time, data representing a panoramic view based on image data outputted by the capturing units, and transmitting the panoramic view data to a client device for display.

### CROSS-REFERENCE TO RELATED APPLICATION

This application is based upon and claims priority from Chinese Patent Application No. 201710051715.3, filed on Jan. 20, 2017, the disclosure of which is expressly incorporated herein by reference in its entirety.

### TECHNICAL FIELD

The present disclosure generally relates to methods and systems for monitoring a scene, and more specifically to methods and systems for monitoring a scene based on data generated in real time representing a panoramic view.

### BACKGROUND

Panoramic view monitoring involves creating a panoramic view of an area of interest from images or videos captured by a camera and presenting the panoramic view to a user. The user may wish to monitor the area of interest in real time, and this presents some challenges to existing methods of providing a panoramic view. One method uses a pan-tilt-zoom (“PTZ”) camera to capture a scene from various angles, and views of the scene captured are stitched to form a panoramic view. The panoramic view can be presented to a client device for non-real-time monitoring. Another method uses multiple wide-lens cameras to produce video streams in multiple channels, the streaming images of which are stitched at an external site to the cameras to provide a panoramic view for post-event monitoring. These methods, however, leave certain requirements unsatisfied. For a PTZ camera using a gimbal or servo motors, the recording quality may be impacted by a poor maneuverability and noise created from the movements of the mechanical gear. The servo system may be prone to mechanical failure. The panoramic view is only provided after the angles of view required to form a panoramic view are all accounted for in turn and then stitched together, thus not offering real-time monitoring. For a monitoring system using multiple wide-lens cameras, multiplexing of the multiple streams from the camera takes up additional bandwidth. Needing more than one camera also incurs higher cost. Moreover, the panoramic view is generated at a processing site external to the cameras, causing delay and inconvenience to monitoring at a client device.

The disclosed methods and systems address one or more of the problems described above.

### SUMMARY

Consistent with the present disclosure, there is provided a method of monitoring a scene based on a panoramic view. The method may include capturing a scene by multiple capturing units, generating, in real time, data representing a panoramic view based on image data outputted by the capturing units, and transmitting the panoramic view data to a client device for display as a panoramic view.

Consistent with the present disclosure, there is provided a method of monitoring a scene based on data generated in real time representing a panoramic view. The method may include establishing a first connection with a capturing device. The capturing device may include multiple capturing units configured to capture the scene and to output image data representing views of the scene and an image processing unit for generating data in real time representing the panoramic view, based on the image data outputted by the capturing units. The method may include establishing a second connection with a client device for receiving the panoramic view data generated by the capturing device, and transmitting the panoramic view data, according to a first transmission protocol, from the capturing device to the client device for monitoring the scene at the client device.

Consistent with the present disclosure, there is provided another method of monitoring a scene based on a panoramic view. The method may include sending to a capturing device a request for transmitting data representing a first panoramic image. The capturing device may include multiple capturing units for capturing a scene and an image processing unit for generating the first panoramic image data in real time based on image data outputted from the capturing units. The method may include receiving the first panoramic image data and displaying a view of the first panoramic image based on the first panoramic image data.

Consistent with the present disclosure, there is provided a system for monitoring of a scene based on a panoramic view. The system may include a capturing device for capturing a scene and generating in real time data representing a panoramic view. The capturing device may include multiple capturing units for capturing the scene and an image processing unit for generating in real time data representing the panoramic view based on image data outputted from the capturing units. The system may include a server configured to connect the capturing device to a client device and to transmit the panoramic view data over a network, according to a transmission protocol, from the capturing device to the client device for display at the client device.

It is to be understood that both the foregoing general description and the following detailed description are exemplary and explanatory only and are not restrictive of the invention, as claimed.

### BRIEF DESCRIPTION OF THE DRAWINGS

Methods, systems, and/or devices described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a system for monitoring of a scene based on data generated in real time representing a panoramic view, consistent with the present disclosure;

FIG. 2 is a flowchart of operating a system for monitoring of a scene based on a panoramic view, consistent with the present disclosure;

FIG. 3 is a flowchart of a method of monitoring a scene based on a panoramic view, consistent with the present disclosure;

FIG. 4 is a flowchart of a method of monitoring a scene based on data generated in real time representing a panoramic view, consistent with the present disclosure; and

FIG. 5 is a flowchart of another method of monitoring a scene based on a panoramic, consistent with the present disclosure.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

Features and characteristics of the present disclosure, as well as methods of operation and functions of related elements of structure and the combination of parts and economies of manufacture, may become more apparent upon consideration of the following description with reference to the accompanying drawings, all of which form a part of this specification. It is to be understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

As used in the present disclosure, an “image” may refer to a visual medium, such as a still image or a frame of a video. “Image data” may refer to data representing a still image, a video stream, or a frame of a video. A “frame” of a video, or “video frame,” may refer to one of a series of still images, the display of which is perceived as a moving image. A “video stream” may refer to a series of video frames for displaying a moving image.

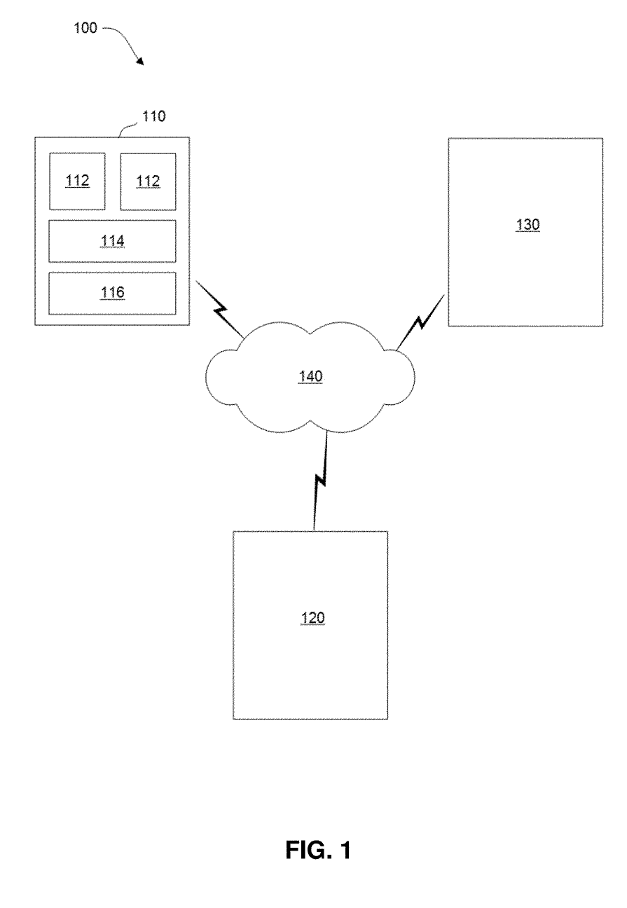

Consistent with the present disclosure, FIG. 1 shows a system 100 for monitoring of a scene based on data generated in real time representing a panoramic view. System 100 may include a capturing device 110 for capturing a scene and generating data representing a panoramic view, a client device 120 for accessing and controlling capturing device 110 and showing the panoramic view, a server 130 for connecting capturing device 110 and the client device 120 and transmitting the panoramic view data over a network 140, according to a transmission protocol, from capturing device 110 to client device 120.

Capturing device 110 may be configured as a dashboard camera, a vehicle-mounted camera, a sport camera, a surveillance camera, a video-conferencing camera, etc., and may include two or more image capturing units 112 for capturing a scene of a premise. The premise may include a certain geographical location, and the contents of the scene may include objects on the premise, including living and nonliving objects. Each capturing unit 112 may be configured to capture a portion of the scene, and capturing units 112 may be arranged so that data representing a panoramic view of the premise, such as a 360° view, a 360° (horizontal)×360° (vertical) view, and a wide angle view, can be generated from the captured scene. One or more of capturing units 112 may include a field of view corresponding to less than a full panoramic view to be generated. However, it may be preferable to minimize or eliminate a blind spot of the capturing device with respect to the scene to be captured. For example, two capturing units 112 may be arranged in capturing device 110 such that each unit can capture a substantially different portion of scene for generation of a panoramic view. The panoramic view generated will have a desired coverage of the scene. A field of view of one capturing unit 112 may overlap with that of another capturing unit.

A capturing unit 112 may include a lens and an image sensor (not shown). An image sensor may include a complementary metal-oxide semiconductor (CMOS) or charge-coupled device (CCD) image sensor. Capturing unit 112 may include additional optical, electrical, and/or mechanical components to achieve image capturing, as well as processing image data. The image sensor may be configured to perform imaging and to output image data, such as data of high definition still images or video streams, e.g., ultra-high definition (“UHD”) video streams, with a 4K resolution of pixels.

Capturing device 110 may include an image processing unit 114 for processing images, including still images or video frames, outputted from capturing units 112. Capturing units 112 may simultaneously output a set of video frames to image processing unit 114, which may simultaneously process the outputted video frames in real time as video streams. Thus, images outputted from capturing units 112 may be immediately processed at capturing device 110, without being transmitted to an external processing site, to generate data representing a panoramic view.

Image processing unit 114 may include a stitcher for generating data representing a panoramic view from images outputted from capturing units 112. The stitcher may be configured to “stitch,” that is, combine, still images into at least a portion of a mosaic, to generate a panoramic image having a panoramic view. For example, the stitcher may be configured to perform a homography transformation to the outputted still images or video frames to generate a panoramic view.

The panoramic view may include a flat, polar, planet, fisheye, and circular effect applied by, for example, image processing unit 114. Alternatively, client device 120 may be configured to apply a graphical effect to a panoramic view transmitted from capturing device 110. The panoramic view may be generated for display by a virtual reality device.

Image processing unit may 114 may include a graphics processing unit and/or circuits for processing images outputted from capturing units 112. Capturing device 110 may include circuits for processing the images on a system-on-chip (“SoC”). For example, image processing unit 114 may be configured to “de-warp,” that is, reduce distortion of, a panoramic image stitched from outputted video frames to generate a flat panoramic view.

Image processing unit 114 may be configured to analyze an image or a panoramic view based on a set of recognition rules. The recognition rules may be preprogrammed and/or defined by a user, and stored in a database of capturing device 110. The recognition rules may include detecting a presence, absence, or change in state or status of a particular object, an environmental attribute, and/or certain information from an image outputted from a capturing unit 112 or a generated panoramic view. For example, the recognition rules may include face recognition, license plate recognition, intruder detection, QR code recognition, and other identifications of information as analyzed from the captured contents.

Image processing unit 114 may include a motion detector to perform the recognition. The motion detector may be configured to mark recognized contents of a panoramic view on the panoramic view.

Capturing units 112 may be configured to start, pause, and stop imaging, such as recording videos, in synchronization with a local clock in capturing device 110. Images, such as video frames, may be timestamped to keep track of the recording or for later processing. Image processing unit 114 may be configured to receive the images directly from captured units 112 via a high-speed interface.

Image processing unit 114 may be configured to process a panoramic view in response to a user action so as to simulate PTZ movements. For example, image processing unit 114 may process a panoramic view to simulate panning or tilting to correspond to a sliding movement a finger across the panoramic view shown on a screen of client device 120. A pinch action from the user may cause image processing unit 114 to perform digital zooming, for example. Alternatively, the simulation of PTZ movements may be performed at client device 120.

Capturing device 110 may be configured to respond to a selection of a region of interest (“ROI”) on a panoramic view. For example, a user viewing a panoramic view displayed on a screen of client device 120 may select an ROI by tapping the screen on the panoramic image, and an area of the image associated with where the tapping was may constitute an ROI. Image processing unit 114 of capturing device 110 may receive a signal carrying information of the selection of the ROI transmitted from client device 120 and respond to the signal by, for example, zooming in on the ROI, reprocessing a portion of the panoramic view corresponding to the ROI, or reprocessing a portion of the panoramic view not corresponding to the ROI. Network interface 116 may be configured to transmit only image data corresponding to the ROI to client device 120. Alternatively, non-ROI image data, such as image data corresponding to an area outside of the ROI, may be transmitted by a lower bit rate than the bit rate for the ROI image data to client device 120.

Image processing unit 114 may be configured to encode contents of the captured images. In particular, image processing unit 114 may be configured to compress a panoramic image to a different quality or bit rate, which may be specified to capturing device 110 by a user or adapted based on a particular transmission protocol used. The compression may be selected based on a hardware limitation, a software limitation, a network limitation, a transmission protocol limitation, and/or a user requirement.

Capturing device 110 may include a storage device for storing a panoramic image generated by image processing unit 114. The storage device may include a memory device connected to capturing device 110. Client device 120 and/or server 130 may include a memory device for storing a panoramic image transmitted from capturing device 110.

Capturing device 110 may include an Internet Protocol (“IP”) camera, or a camera capable of communicating with client device 120 and server 130. Thus, capturing device 110 may include a network interface 116 for connecting to a network in a wired and/or wireless configuration. Network interface 116 may be configured to establish a connection with client device 120 and server 130 and transmit an image, which may include a panoramic view, over network 140 to client device 120 and server 130. Network 140 may include a wired and/or wireless network, and network interface 116 may be configured to connect to a wired network and a wireless network simultaneously. Network interface 116 may be configured to transmit image data over a wired network while receiving and sending non-image data, such as commands received from client device 120 and status signals sent from capturing device 110 to client device 120, over a wireless network.

Client device 120 may include a smartphone, a tablet computer, a PC, a virtual reality device, and other personal or mobile electronic devices for communicating with capturing device 110 and server 130. Client device 120 may include a software application for accessing and controlling capturing device 110, such as by instructing capturing device 110 to transmit data representing a panoramic view from capturing device 110 to client device 120. Client device 120 may be configured to allow a user to identify capturing device 110, start, pause, and stop capturing device 110 to capture a scene, start a transmission of data representing a panoramic view from capturing device 110 to client device 120 or server 130, and share a panoramic view with other devices by broadcasting a panoramic video stream, for example.

Client device 120 may provide a set of physical and/or virtual controls allowing the user to select a certain operation, such as one or more of the foregoing actions, for capturing device 110. A user may access and control capturing device 110 from an interface of client device 120 receiving tactile, mechanical, electrical, voice, and/or other sensory inputs. Client device 120 may be mobile, and may allow a user to remotely monitor a scene based on a panoramic view transmitted to and displayed on client device 120.

Client device 120 may be configured to receive a selection of an ROI and instruct capturing device 110 to respond to the selection of an ROI. By selecting an ROI in real time, capturing device 110 may be configured to respond immediately to the selection and generate data representing an updated the panoramic view, for example.

Client device 120 may include a display device for showing a panoramic view transmitted from capturing device 110. Client device 120 may be configured to provide information about the panoramic view to help the user identify the view and/or contents of the view. Displaying a panoramic view and/or provision of additional information about the panoramic view may allow a user to monitor, in real time, the scene captured. Client device 120 may be configured to access a panoramic image previously generated for non-real-time viewing.

Client device 120 may be configured to facilitate device-pairing with capturing device 110. For example, client device 120 may be configured to allow a user to create a user account, log on the user account, identify and register capturing device 110, and pair capturing device 110 with the user account.

Client device 120 may be configured to register a user account with a service providing device registration. Such service may be provided by server 130, or another server communicating with server 130. Via client device 120, capturing device 110 may be registered with the same service client device 120 may also have been registered. Information about device-pairing between client device 120 and a user account may be transmitted to the device registration service or server 130 by capturing device 110 or client device 120.

Server 130 may be configured to establish a connection between capturing device 110 and client device 120 upon request by capturing device 110 or client device 120. Server 130 may be configured to adopt a transmission protocol to enable transmission, or streaming, of a panoramic image from capturing device 110 to client device 120. A transmission protocol ensuring low latency may be preferable for the purpose of real-time monitoring. In other situations, a transmission protocol providing a broadcasting function may be preferred in order to transmit a panoramic image to a number of terminal devices, including client devices such as smartphones and computers and applications on those devices such as webpages or other software applications.

Server 130 may be configured to provide a direct connection between capturing device 110 and client device 120 such that a panoramic image can be directly transmitted from capturing device 110 to client device 120. Server 130 may also be configured to provide an indirect connection between capturing device 110 and client device 120 such that a panoramic image can be first transmitted to server 130 and then transmitted to client device 120 from server 130. For example, server 130 may include Real-time Transport Protocol (“RTP”), Real-Time Streaming Protocol (“RTSP”), Real-Time Messaging Protocol (“RTMP”), Peer-To-Peer (“P2P”) protocol, or other similar transmission protocols, or variants thereof.

The establishment of a connection and/or transmission of data representing a panoramic view between capturing device 110 and client device 120 may be event-based. Capturing device 110 may determine if a particular event has occurred, such as by detecting an object in the captured scene, or by detecting an environmental attribute, and, if the event has occurred, request server 130 to provide a connection to client device 120. Likewise, client device 120 may request a connection with capturing device 110 when a user-triggering event, for example, starting an application for monitoring at client device 120, has occurred.

Server 130 may be configured to issue an alarm to client device 120 to inform that a specific event may have happened based on a determination of the captured scene at capturing device 110. As part of the alert or along with the alert, data representing a panoramic view of the scene captured may be transmitted in real time to client device. The alarm may include video streaming of a panoramic view. This kind of “video alarm” may also be directly alerted to client device 120 by capturing device 110. For example, an alert may be sent directly from capturing device 110 to client device 120, while a transmission of data representing a panoramic view from capturing device 110 to client device 120 may follow the rules of the particular transmission protocol used for the transmission.

Server 130 may be configured to receive image data, including data constituting a panoramic image, from capturing device 110 on a continuous basis. For example, capturing device 110 may be configured to record a scene on a full-time or long term basis and continuously transmit a panoramic video generated based on the recorded video data to server 130 for storage. Stored panoramic videos may be sorted into a list and represent a recording history, and a panoramic video may be selected from the list for transmission to client device 120 for viewing. With respect to storing the videos, server 130 may be configured to provide a cloud storage or cloud service to which client device 120 may gain access. Server 130 may be configured to store backup copies of panoramic images when capturing device 110 and/or client device 120 may store the images locally.

Server 130 may be configured to process image data transmitted from capturing device 110. For example, server 130 may be configured to process a panoramic video transmitted from capturing device 110 for graphic processing or broadcasting or to provide additional information to the video. Server 130 may be configured to perform specialized and/or customized graphic processing to a panoramic image and transmit the “processed” panoramic image to client device 120 and/or other terminal devices.

As described above, server 130 may be configured to register a user account from client device 120. Server 130 may be configured to authenticate a request to access capturing device 110 from other terminal devices based on information of a user account, capturing device 110, and/or client device 120. Server 130 may include a database for storing the pairing information, registration information, account information, device information, access information, and transmission records.

Server 130 may include a virtual machine to be configured as consistent with the present disclosure.

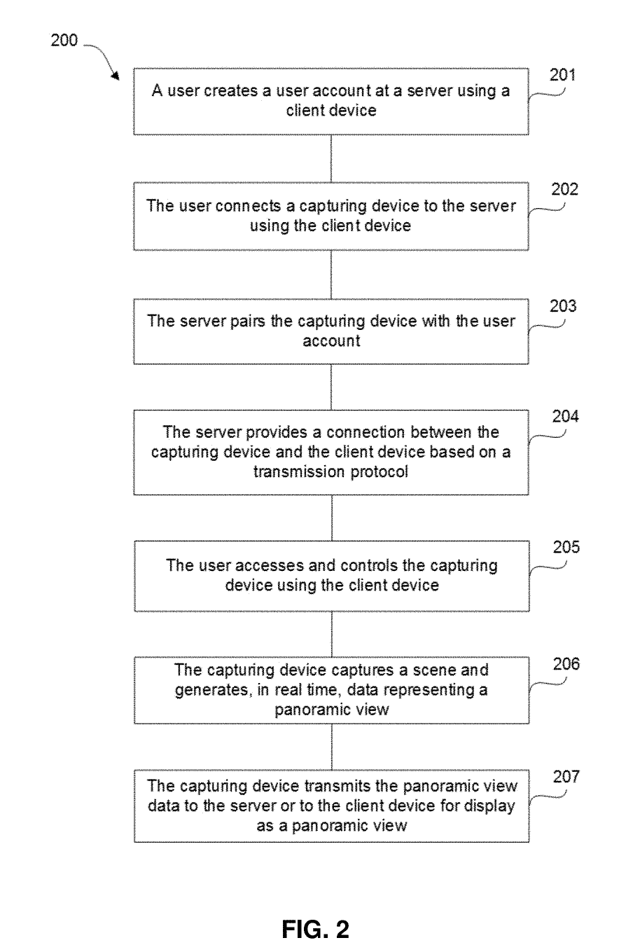

Referring now to FIG. 2, there is shown a flowchart depicting an exemplary method 200 for operating a system for monitoring of a scene based on data generated in real time representing a panoramic view. Method 200 may be implemented using system 100 or a part thereof. It is to be noted that the present disclosure is not limited by the order of the steps of method 200 described below. Consistent with the present disclosure, an operation of a system for monitoring of a scene based on data generated in real time representing a panoramic view may have less or more steps than method 200, and may have a different order of steps from method 200.

In step 201, a user creates a user account at a server using a client device. The user may create a user account using a software application running on the client device. The software application may be configured to transmit user information to the server to create the user account. The server may be configured to register the user account in a database of the server, and may also register the client device in the database along with the user account.

In step 202, the user connects a capturing device to the server using the client device. A capturing device may require set up, including establishing a connection to the server. The user may use the client device to generate and display a QR code on a screen of the client device. The QR code may embed an access code of a network. The capturing device may be configured to capture the QR code displayed by the client device and access a network to connect to the server. The capturing device may be configured to establish a connection with the server once the capturing device has access to the network.

In step 203, the server pairs the capturing device with the user account. To pair with the user account, the capturing device may be configured to upload information about the capturing device, along with the account information, to the server, and the server may be configured to pair the capturing device with the user account based on the request and information received from the capturing device.

In step 204, the server provides a connection between the capturing device and the client device based on a transmission protocol. The server may be configured to provide a connection between the capturing device and the client device to enable a transmission, to the client device, of data generated in real time representing a panoramic view at the capturing device based on a transmission protocol. In addition, the server may be configured to provide a broadcasting service to enable a panoramic view represented by data generated in real time at the capturing device to be transmitted to multiple terminal devices based on a transmission protocol.

In step 205, the user accesses and controls the capturing device using the client device. The client device may send instructions inputted by the user to the capturing device. The instructions may be sent over a WiFi network or the Internet. For example, the user may instruct the capturing device to start or stop capturing a scene, transmit data representing a panoramic view of a scene being captured, select an ROI, transmit video data corresponding to the ROI, etc.

In step 206, the capturing device captures a scene and generates, in real time, data representing a panoramic view. Multiple capturing units of the capturing device may start capturing the scene, and an image processing unit of the capturing device may generate, in real time, a panoramic video having a panoramic view based on videos outputted from the capturing units.

In step 207, the capturing device transmits the panoramic view data to the server or to the client device. Depending on the user preference and the transmission protocol employed by the server, data generated in real time representing a panoramic view at the capturing device may be transmitted to the client device for display as a panoramic view, and/or to the server for storage or broadcasting to multiple terminal devices. The user may view the panoramic view on the client device to monitor the scene.

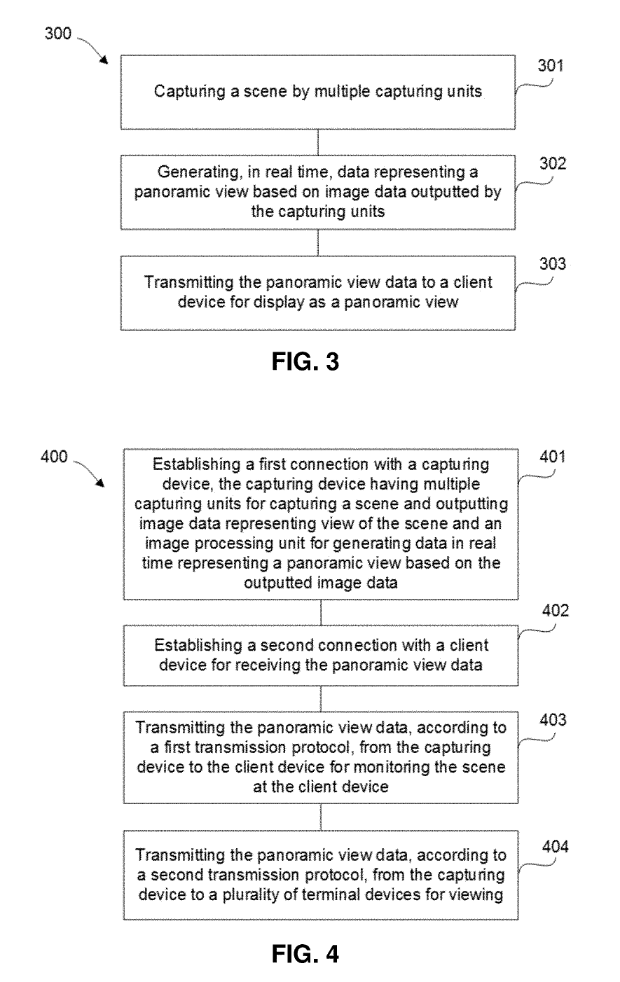

Referring now to FIG. 3, there is shown a flowchart of a method 300 of monitoring a scene based on a panoramic view. Method 300 may be implemented based on the flowchart, or a part thereof, shown in FIG. 2. Method 300 may be implemented using system 100 or a part thereof. In step 301, a capturing device having multiple capturing units is provided for capturing a scene. The capturing units may be configured to capture the scene. The scene may be captured by the capturing units operating simultaneously. Each capturing unit may be configured to capture a portion of the scene corresponding to a panoramic view to be generated.

In step 302, data representing a panoramic view is generated in real time by the capturing device based on image data, such as image data constituting video frames, outputted by the capturing units. The outputted video frames may be stitched by an image processing unit of the capturing device to generate data in real time representing the panoramic view.

In step 303, the panoramic view data is transmitted from the capturing device to a client device for display as a panoramic view. The panoramic view data may be transmitted based on a transmission protocol. The transmission of the panoramic view data to the client device may be provided by a server employing the transmission protocol. The panoramic view may be displayed on a screen of the client device for monitoring.

In method 300, the capturing device may be responsive to a selection of an ROI on the panoramic view displayed on the client device by transmitting data representing an updated panoramic view to the client device based on the selection of the ROI. A transmission of the updated panoramic view data may include transmitting only video data corresponding to the ROI. Video data corresponding to an area outside the ROI may not be transmitted to the client device, or may be transmitted in a low bit rate to the client device.

Referring now to FIG. 4, there is shown a flowchart of a method 400 of monitoring a scene based on data generated in real time representing a panoramic view. Method 400 may be implemented based on the flowchart, or a part thereof, shown in FIG. 2. Method 400 may be implemented using system 100 or a part thereof. In step 401, a server establishes a first connection with a capturing device having multiple capturing units for capturing a scene and an image processing unit for generating data in real time representing a panoramic view based on image data outputted by the capturing units.

In step 402, the server establishes a second connection with a client device for receiving data representing a panoramic view generated by the capturing device.

In step 403, the server provides a first transmission protocol to enable a transmission of data representing a panoramic view from the capturing device to the client device for monitoring at the client device. The panoramic view data may be generated by the image processing unit based on image data outputted by the capturing units.

In step 404, the server provides a second transmission protocol to enable the panoramic view data generated by the capturing device to be transmitted to a plurality of terminal devices for viewing.

In method 400, the server may store a video having the panoramic view generated by the capturing device. The server may provide a panoramic video previously generated by the capturing device to the client device and/or other terminal devices.

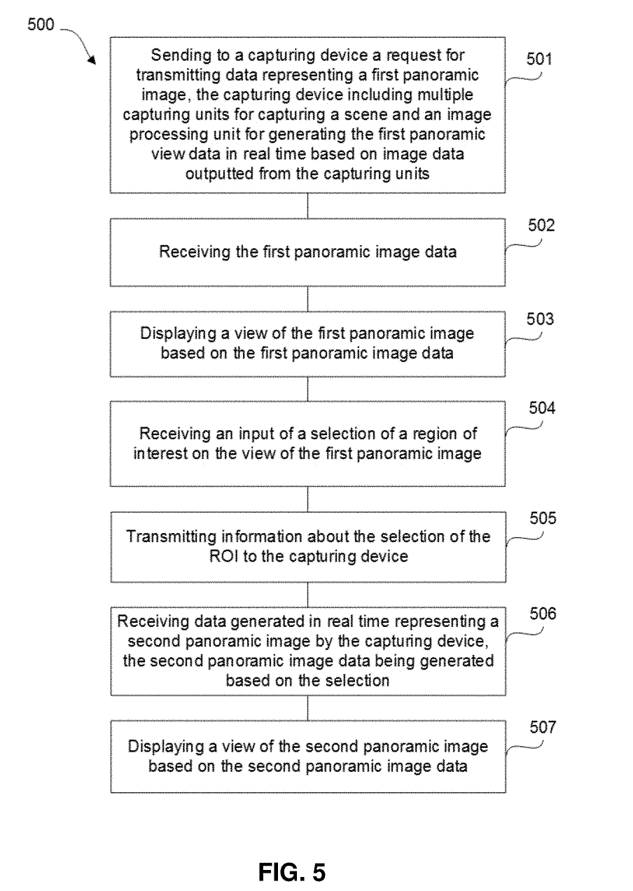

Referring now to FIG. 5, there is shown a flowchart of a method 500 of monitoring a scene based on a panoramic view. Method 500 may be implemented based on the flowchart, or a part thereof, shown in FIG. 2. Method 500 may be implemented using system 100 or a part thereof. In step 501, a client device sends a request to a capturing device to transmit a panoramic image. The panoramic image may include a panoramic still image or a panoramic video stream. The capturing device may include multiple capturing units for capturing a scene and an image processing unit for generating, in real time, data representing a panoramic view based on image data outputted by the capturing units.

In step 502, the client device receives data representing a first panoramic image generated in real time by the capturing device.

In step 503, the client device displays a view of the first panoramic image based on the first panoramic image data.

In step 504, the client device receives an input to select an ROI on the first panoramic image.

In step 505, the client device sends information about the selection of the ROI to the capturing device.

In step 506, the client device receives data generated in real time representing a second panoramic image by the capturing device, based on the selection of the ROI.

In step 507, the client device displays a view of the second panoramic image based on the second panoramic image data.

In method 500, the client device may provide options to apply a flat, polar, planet, fisheye, and circular effect to a view of the first or second panoramic image.

While illustrative embodiments have been described herein, the scope of any and all embodiments have equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed processes may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A method of monitoring a scene based on a panoramic view, comprising:
capturing a scene by multiple capturing units;
generating, in real time, data representing a panoramic view based on image data outputted by the capturing units; and
transmitting the panoramic view data to a client device for display as a panoramic view.

2. The method of claim 1, wherein transmitting the panoramic view data comprises transmitting the panoramic view data based on a transmission protocol provided by a server.

3. The method of claim 1, wherein capturing a scene by multiple capturing units comprises capturing, by each of the capturing units, a portion of the scene corresponding to a part of the panoramic view.

4. The method of claim 1, wherein generating the panoramic view data comprises:
generating data representing video frames; and
stitching the video frame data to generate the panoramic view data in real time.

5. The method of claim 1, further comprising:
receiving, from the client device, a selection of a region of interest on the panoramic view displayed on the client device;
generating data representing an updated panoramic view based on the selection; and
transmitting the updated panoramic view data to the client device for display as an updated panoramic view.

6. The method of claim 5, wherein transmitting the updated panoramic view data comprises transmitting only image data corresponding to the region of interest.

7. The method of claim 5, wherein transmitting the updated panoramic view data comprises:
transmitting image data corresponding to an area inside of the region of interest at a first bit rate; and
transmitting image data corresponding to an area outside of the region of interest at a second bit rate, the second bit rate being lower than the first bit rate.

8. A method of monitoring a scene based on data generated in real time representing a panoramic view, comprising:
establishing a first connection with a capturing device, the capturing device comprising:
multiple capturing units configured to capture the scene and to output image data representing views of the scene; and
an image processing unit for generating data in real time representing the panoramic view, based on the image data outputted by the capturing units;
establishing a second connection with a client device for receiving the panoramic view data generated by the capturing device; and
transmitting the panoramic view data, according to a first transmission protocol, from the capturing device to the client device for monitoring the scene at the client device.

9. The method of claim 8, further comprising:
transmitting the panoramic view data, according to a second transmission protocol, from the capturing device to a plurality of terminal devices for viewing.

10. The method of claim 8, further comprising:
storing the panoramic view data generated by the capturing device.

11. The method of claim 8, further comprising:
transmitting to the client device data representing a panoramic view previously generated by the capturing device.

12. The method of claim 8, wherein the first transmission protocol comprises at least one of Real-time Transport Protocol, Real-Time Streaming Protocol, Real-Time Messaging Protocol, or Peer-To-Peer protocol.

13. The method of claim 8, further comprising:
providing pairing the capturing device with a user account accessed via the client device.

14. The method of claim 8, further comprising:
issuing an alarm to the client device based on an event detected by the capturing device from a panoramic view.

15. A method of monitoring a scene based on a panoramic view, comprising:
sending to a capturing device a request for transmitting data representing a first panoramic image, the capturing device comprising:
multiple capturing units for capturing a scene; and
an image processing unit for generating the first panoramic image data in real time based on image data outputted from the capturing units;
receiving the first panoramic image data; and
displaying a view of the first panoramic image based on the first panoramic image data.

16. The method of claim 15, further comprising:
receiving an input of a selection of a region of interest on the view of the first panoramic image;
transmitting the selection to the capturing device;
receiving data generated in real time representing a second panoramic image by the capturing device, the second panoramic image data being generated based on the selection; and
displaying a view of the second panoramic image based on the second panoramic image data.

17. The method of claim 15, wherein the first panoramic image comprises at least one of a flat effect, a polar effect, a planet effect, a fisheye effect, or a circular effect.

18. A system for monitoring of a scene based on a panoramic view, comprising:
a capturing device for capturing a scene and generating in real time data representing a panoramic view, the capturing device comprising:
multiple capturing units for capturing the scene; and
an image processing unit for generating in real time data representing the panoramic view based on image data outputted from the capturing units; and
a server configured to:
connect the capturing device to a client device; and
transmit the panoramic view data over a network, according to a transmission protocol, from the capturing device to the client device for display at the client device.

19. The system of claim 18, wherein the capturing device is configured to receive from the client device instructions for controlling the capturing device.

20. The system of claim 18, wherein the capturing device comprises an image processing unit for stitching images outputted from the capturing units to generate, in real time, data representing the panoramic view.
